(19) United States
(12) Patent Application Publication
(10) Pub. No.: US 2026/0271892 A1
(43) Pub. Date: Sep. 17, 2026

(54) SYSTEM AND METHOD FOR SHELLFISH AQUAFARMING

(71) Applicant: SUMMIT OYSTERS LTD., Comox (CA)

(72) Inventors: Casey Johnson, Comox (CA); Duane Johnson, Royston (CA)

(73) Assignee: SUMMIT OYSTERS LTD., Comox (CA)

(21) Appl. No.: 19/567,448

(22) Filed: Mar. 16, 2026

Related U.S. Application Data
(60) Provisional application No. 63/771,964, filed on Mar. 14, 2025.

(51) Int. Cl. A01K 61/55

(52) U.S. Cl. CPC A01K 61/55

(57) ABSTRACT

There is an aquafarming system, a container tumbling device and a method for aquafarming. The aquafarming system has shellfish containers and a container tumbling device that guides the containers and engages them to facilitate the rotation of the containers about their central axis as they move through and under the container tumbling device. To do so, the container tumbling device has a housing having a bracket and upper portion, a guiding mechanism to guide the containers, and an engaging mechanism to rotate the containers. The container tumbling device is configured to be secured to a boat. The method for aquafarming is to arrange the containers along lines in the water and driving a boat having the container tumbling device so that the tumbling device rides over the containers. By riding over them, the shellfish containers are rotated and the oysters within them tumbled.

### CROSS-REFERENCE TO A RELATED APPLICATION

The present application claims priority to U.S. Provisional Application No. 63/771,964, entitled “SYSTEM AND METHOD FOR SHELLFISH AQUAFARMING” filed on Mar. 14, 2025, the contents of which are incorporated herein by reference in their entirety.

### FIELD OF THE DISCLOSURE

The disclosure relates generally to the field of shellfish aquafarming and more specifically to a system and method for oyster cleaning and farming.

### DESCRIPTION OF THE RELATED ART

Traditionally, oysters are grown on beaches. The process involves spreading oysters out on the beach, letting them grow and going back to harvest them. This process is difficult work that takes a lot of labour, and oysters grown on the beach are susceptible to being eaten by predators such as crab and starfish. Eventually, farmers built cages to protect and grow the oysters, but these systems were also labor intensive. In the 1990s, the industry started moving to deep water aquaculture and floating aquaculture. In British Columbia, deep water was the main method using raft and longline systems; however, in other parts of the world floating bags or cages were used. For deep water aquafarming, the idea was to put oysters in a stack, suspend them under a raft or longline to have oysters ready to harvest after about 6 months. Unfortunately, this methodology created numerous shortcomings.

Pacific oysters are the main oysters grown in British Columbia; they grow quickly and put out new growth around the outside perimeter of the shell (frill). Growing these oysters on the beach was ineffective: their growth would be stunted and their shells hardened because of sitting out of the water when the tide was low; however, this problem did not occur in deep waters. Unfortunately, there pacific oysters grew substantial new and the shells got soft and chalky.

About three decades ago, an idea was devised to tumble the oysters to slow down their growth and harden their shell. Another benefit of tumbling the oysters is that it knocks off any fouling that would set and grow on the oysters while they are in the trays (e.g. barnacles, muscles, seaweed, and the like). The tumbling process also created a larger abductor muscle, which is the muscle that holds the oyster closed. This increased shelf life added a sweeter flavour to the oyster. Since then, many aquafarmers have been trying to duplicate the process and the appearance of the oyster.

System and methods of tumbling oysters have evolved significantly since then. These days, a long line system is used, whereby oysters are put into large cylinders with circular trays and tumbled at the surface of the water with floats. However, this system has many drawbacks, including but not limited to: insufficient tumbling/agitation especially on hot days with calm waters, trays getting dirty creating a bad environment for the oysters (high mortality rate) and not enough flush (insufficient water going through the system).

As such, there is a need for a novel type of aquaculture system for oysters that can overcome the problems of the prior art. More specifically, a system that can tumble/flush the oysters 1 to 2 times per day in the summer and keep itself clean spotless while reducing manual labour.

### SUMMARY OF THE DISCLOSURE

In an embodiment, the present disclosure provides an aquafarming system comprising: at least one shellfish container to grow shellfish; a container tumbling device operatively engaged with the at least one shellfish container, the container tumbling device further comprising: an engaging mechanism configured to actuate the at least one shellfish container as the at least one shellfish container passes through the container tumbling device and below the engaging mechanism.

In another embodiment, the present disclosure provides a container tumbling device for use in aquafarming, comprising: a housing having brackets; and an engaging mechanism secured to the brackets of the housing, the engaging mechanism configured to actuate at least one shellfish container as the at least one shellfish container passes through and below the container tumbling device; in which the bracket is operable to secure the container tumbling device to a vessel.

In yet another embodiment, the present disclosure provides a method for tumbling a plurality of shellfish containers, the steps comprising: arranging the plurality of shellfish containers along a pair of lines; and running the plurality of shellfish containers through and below a container tumbling device comprised of: a housing having brackets; and an engaging mechanism secured to the brackets of the housing; in which the plurality of shellfish containers cooperates with the pair of lines to be guided relative to the container tumbling device, and in which the engaging mechanism rotates the plurality of shellfish containers as the plurality of shellfish containers travels under and through the container tumbling device.

### BRIEF DESCRIPTION OF THE DRAWINGS

The following figures serve to illustrate various embodiments of the disclosure. These figures are illustrative and are not intended to be limiting.

FIG. 1 is a perspective view of a system for shellfish aquafarming, according to an embodiment of the present disclosure.

FIG. 2 is a perspective view of a container tumbling device for use with the system of FIG. 1, according to an embodiment of the present disclosure.

FIG. 3 is an enlarged perspective view of guiding and engaging mechanisms of the container tumbling device for use with the system of FIG. 1, according to an embodiment of the present disclosure.

FIG. 4 is a perspective view of a system for shellfish aquafarming, according to another embodiment of the present disclosure.

FIG. 5 is an enlarged perspective view of guiding and engaging mechanisms of the container tumbling device for use with the system of FIG. 4, according to another embodiment of the present disclosure.

FIG. 6 is a perspective view of a system for shellfish aquafarming, according to yet another embodiment of the present disclosure.

FIG. 7 is a perspective view of a container tumbling device for use with the system of FIG. 6, according to yet another embodiment of the present disclosure.

FIG. 8 is an enlarged perspective view of guiding and engaging mechanisms of the container tumbling device for use with the system of FIG. 6, according to yet another embodiment of the present disclosure.

### DETAILED DESCRIPTION OF THE DISCLOSURE

The following embodiments are merely illustrative and are not intended to be limiting. It will be appreciated that various modifications and/or alterations to the embodiments described herein can be made without departing from the disclosure and any modifications and/or alterations are within the scope of the contemplated disclosure.

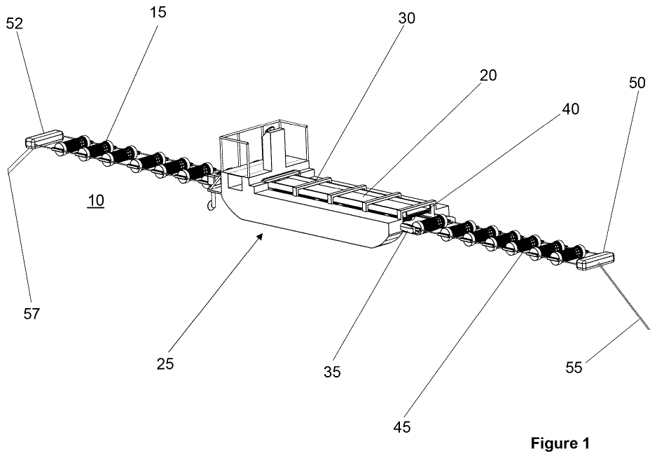

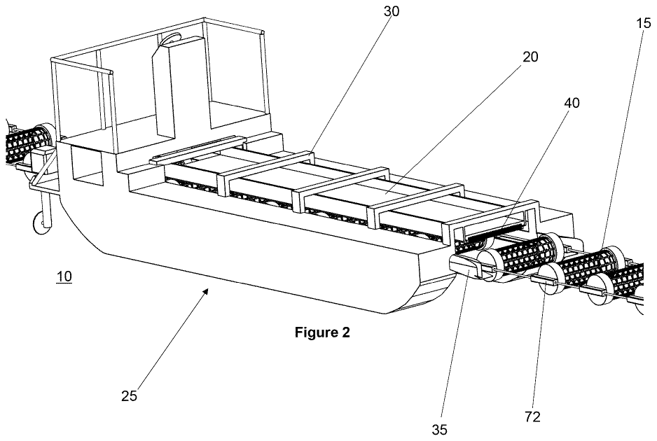

With reference to FIGS. 1, 2 and 3 and according to an embodiment of the present disclosure, an aquafarming system 10 is shown. The aquafarming system 10 further comprises at least one shellfish container 15 to grow shellfish and a container tumbling device 20 operatively engaged with the at least one shellfish container 15. In the present embodiment, the container tumbling device 20 is shown constructed as part of a pontoon 25; however, in another embodiment, the container tumbling device 20 can be attached to a pontoon 25 or other type of ship instead. The container tumbling device 20 can further comprises a guiding mechanism 35 to guide the shellfish containers 15 through the container tumbling device 20. The container tumbling device 20 is comprised of an engaging mechanism 40 configured to rotate and clean the shellfish containers 15 as the shellfish containers pass through the container tumbling device. As shown, it is typical for a plurality of shellfish containers 15 to be disposed longitudinally in the water, typically in a horizontal manner along one or more lines 45 as best shown in FIG. 1. The lines 45 may terminate in a pair of buoys 50, 52 anchored to the seabed by cables 55, 57. The shellfish containers 15 remain on the water surface, partially submerged but able to rotate about an axis. Indeed, the shellfish containers 15 are generally cylindrically shaped, having a mesh housing 60 capped by a pair of opposed crowns 65, 67. In the present embodiment, the shellfish containers 15 also comprises a pair of opposed brackets 70, 72 positioned beyond the crowns 65, 67, respectively. The brackets 70, 72 have a central opening (not shown) to receive the pair of lines 45. In this way, the shellfish containers 15 are disposed along and secured to the lines 45. In another embodiment, the brackets 70, 72 can comprises a connector such as a screw eye to be disposed along the pair of lines 45. In yet another embodiment, the brackets 70, 72 can be clamped in place along the pair of lines 45. The shellfish containers 15 are also comprise an axle 75 extending longitudinally, generally along the center of the shellfish containers 15. The axle 75 extends through the crowns 65, 67 and is secured into each of the opposed brackets 70, 72. The axle 75 therefore enables the shellfish containers 15, including the crowns 65, 67, to rotate about their central axis. The crowns 65, 67 are configured to float and therefore provide flotation to the shellfish containers 15, enough for the shellfish containers 15 to be partially submerged in the water. A worker skilled in the art would appreciate that although brackets 70, 72 are shown, any suitable retention member can be used,

It is understood that although the present container tumbling device 20 is formed part of a pontoon 25, other embodiments are possible. For example, the container tumbling device 20 can have a pair of brackets (not shown) secured to an upper portion 30 to be secured alongside a ship. In another embodiment, the container tumbling device 20 can be a detachable pod that can be used in conjunction with a boat or on its own in the water. In yet another embodiment, the container tumbling device 20 can simply include brackets that extend from a housing to receive the container tumbling device 20. Further, the guiding mechanism 35 may be omitted entirely from the aquafarming system 10. Indeed, the aquafarming system 10 can simply align the container tumbling device 20 or other structure with the containers 15, provided that the containers 15 pass below the engaging mechanism 40 for rotation, cleaning, and the like.

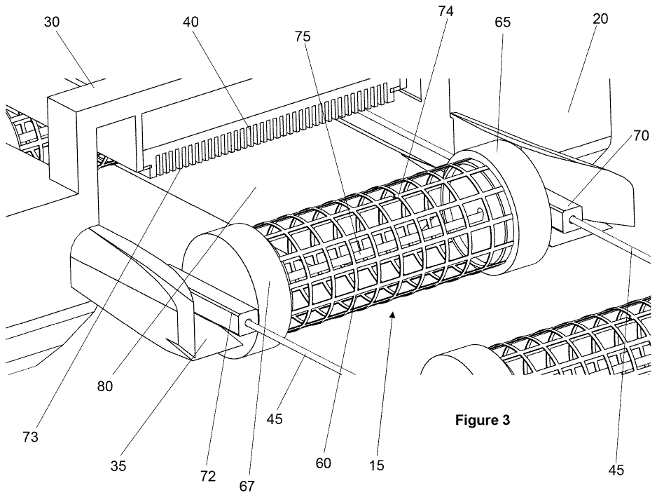

With further reference to FIG. 3 and according to an embodiment of the present disclosure, the upper portion 30 of the container tumbling device 20 has an engaging mechanism 40 configured to rotate and clean the shellfish containers 15 as they pass through and under the container tumbling device 20. The engaging mechanism 40 projects downwardly from the upper portion 30. The engaging mechanism 40 further comprises of a lower surface 73 that actuates an upper segment 74 of the container 15. The upper segment 74 can extend along the entire length of the container 15 or may be a specific portion thereof. In either case, the upper segment 74 is at the top of the container 15. Indeed, in the present embodiment, the engaging mechanism 40 is a traction surface that can be a plurality of brushes; however, other mechanisms of engaging the shellfish containers 15 to rotate and clean them may be suitable. The dual engaging function of the brushes to both rotate and clean the containers 15 is desirous to grow healthier shellfish with a lower mortality rate. As shown, the brushes would extend generally along the length of container tumbling device 20. The container tumbling device 20 has a guiding mechanism 35 that is adapted to receive the brackets 70, 72 thereby guiding the shellfish containers 15 through and under the container tumbling device 20. In the present embodiment not intended to be limiting, the guiding mechanism 35 is a pair of longitudinal ramps having a sloping outer face that define an opening 80. However, other mechanical structures are possible, provided that they guide the length of the shellfish containers 15 into and under the tumbling device 20. By way of example not intended to be limiting, the guiding mechanism 35 can include a series of opposed wheels or rollers. In yet another embodiment, the guiding mechanism can be omitted from the container tumbling device 20 altogether, and in such an embodiment, the opening 80 of the container tumbling device 20 would simply align with and receive the containers 15 to engage the engaging mechanism 40. In an embodiment, the engaging mechanism 40 is actuatable to move up and down, for example mechanically or electromechanically. Actuation can be by hydraulics, rack and pinion, cam and follower, linear actuator, stepper or servo motor, and the like, without departing from the scope of the disclosure. In another embodiment, the entire container tumbling device 20 is actuatable to move and down, thereby moving the engaging mechanism 40 accordingly. Adjustment of the height of the container tumbling device 20 or the engaging mechanism 40 affects a height of the traction surface (e.g. brushes) that contact the shellfish containers 15. In this way, the engaging mechanism 40 can rotate and clean shellfish containers 15 having different diameters. The adjustability of the height also allows an operator of the container tumbling device 20 to change the amount of downward pressure on the shellfish container 15 to get a preferred amount of traction.

With further reference to FIGS. 1, 2 and 3 and according to an embodiment of the present disclosure, during operation, the container tumbling device 20, which would be secured to the boat 25, passes over and along the line of shellfish containers 15. To do so, the opening 80 of the guiding mechanism 35 is aligned with the first shellfish container 15 along the length of the shellfish containers 15. As the container tumbling device 20 approaches the length of the shellfish containers 15, the guiding mechanism 35 receives the first set of brackets 70, 72 of the first shellfish container 15. As the shellfish containers 15 are spread along the lines 45, subsequent adjacent shellfish containers 15 follow the first shellfish container 15 through and under the container tumbling device 20. Once into the opening 80, an upper portion of the mesh housing 60 of the shellfish containers 15 contacts the lower surface 73 of the engagement mechanism 40. As the shellfish containers 15 are configured to rotate about their central axle 75, this cooperation between the lower surface 73 of the engagement mechanism 40 and the mesh housing 60 forces the shellfish containers 15 to rotate about axle 75. The shellfish contained within the shellfish containers 15 tumble by virtue of this rotation. As the lower surface 73 of the engagement mechanism 40 is generally disposed about the length of the container tumbling device 20, continued movement of the boat 25 along the length of shellfish containers 15 engenders continued rotation of the shellfish containers 15 while moving underneath the container tumbling device 20. It is to be understood that the lower surface 73 of the engagement mechanism 40 does not need to be uniformly disposed along the entire length of the container tumbling device 20, but can instead be positioned along segments of the container tumbling device 20, thereby still ensuring a continued and repetitive rotation of the shellfish containers 15 and tumbling of the oysters within them.

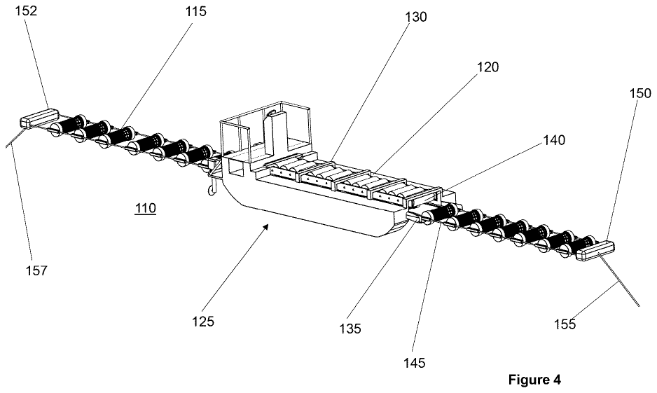

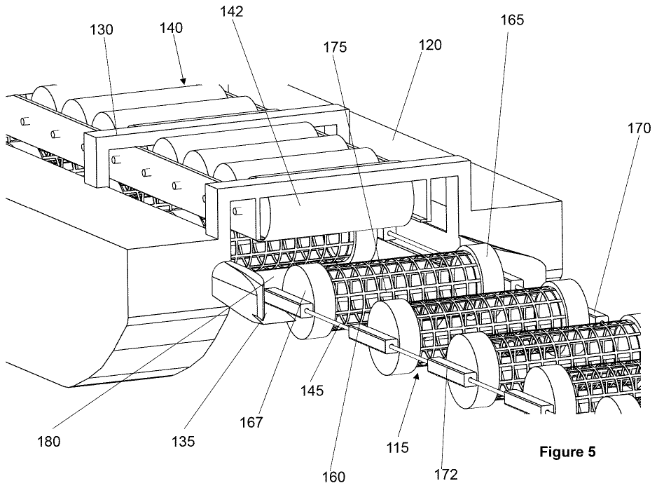

With reference to FIGS. 4 and 5 and according to another embodiment of the present disclosure, an aquafarming system 110 is shown. The aquafarming system 110 further comprises at least one shellfish container 115 to grow shellfish and a container tumbling device 120 operatively engaged with the at least one shellfish container 115. In the present embodiment, the container tumbling device 120 is shown constructed as part of a pontoon 125; however, in another embodiment, the container tumbling device 120 can be attached to a pontoon 125 or other type of ship instead. The container tumbling device 120 further comprises a guiding mechanism 135 to guide the shellfish containers 115 through the container tumbling device 120 as well as an engaging mechanism 140 configured to rotate the shellfish containers 115 as the shellfish containers pass through the container tumbling device. By way of example not intended to be limiting, the guiding mechanism 135 can instead be a series of opposed wheels or rollers. In yet another embodiment, the guiding mechanism 135 can be omitted from the container tumbling device 120 altogether, and in such an embodiment, the opening 180 of the container tumbling device 120 would simply align with and receive the containers 115 to engage the engagement mechanism 140. As shown, it is typical for a plurality of shellfish containers 115 to be disposed longitudinally in the water, typically along one or more lines 145 as best shown in FIG. 4. The lines 145 can terminate in a pair of buoys 150, 152, the buoys 150, 152, anchored to the seabed by cables 155, 157. The shellfish containers 115 remain on the water surface, partially submerged but able to rotate about an axis. Indeed, the shellfish containers 115 are generally cylindrically shaped, having a mesh housing 160 capped by a pair of opposed crowns 165, 167. In the present embodiment, the shellfish containers 115 also comprise a pair of opposed brackets 170, 172 positioned beyond the crowns 165, 167, respectively. The brackets 170, 172 have a central opening (not shown) to receive the pair of lines 145. In this way, the shellfish containers 115 are disposed along and secured to the cables 145. In another embodiment, the brackets 170, 172 can be comprised of a connector such as a screw eye to be disposed along the pair of lines 145. In yet another embodiment, the brackets 170, 172 can be clamped in place along the pair of lines 145. The shellfish containers 115 also comprise an axle 175 extending longitudinally, generally along the center of the shellfish containers 115. The axle 175 extends through the crowns 165, 167 and is secured into each of the opposed brackets 170, 172. The axle 175 therefore enables the shellfish containers 115, including the crowns 165, 167, to rotate about their central axis. The crowns 165, 167 are configured to float and therefore provide flotation to the shellfish containers 115, enough for the shellfish containers 115 to be partially submerged in the water.

With further reference to FIG. 5 and according to an embodiment of the present disclosure, the upper portion 130 of the container tumbling device 120 has an engaging mechanism 140 configured to rotate the shellfish containers 115 as they pass through and under the container tumbling device 120. In this alternate embodiment, the engaging mechanism 140 is a plurality of roller brushes 142. These roller brushes 142 are configured to spin towards the front of the container tumbling device 120. In another embodiment, the roller brushes 142 can be configured to spin towards the back of the container tumbling device 120. As the container tumbling device 120 moves down the line of shellfish containers 115, the rollers 142 spin the shellfish containers 115. In this embodiment, the rollers 142 would be spun mechanically to ensure corresponding rotation of the containers 115.

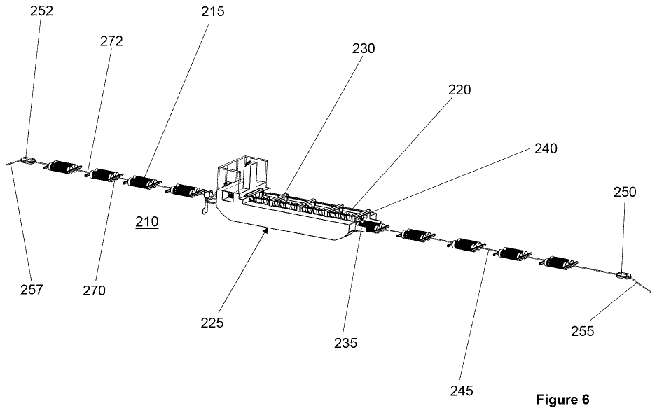

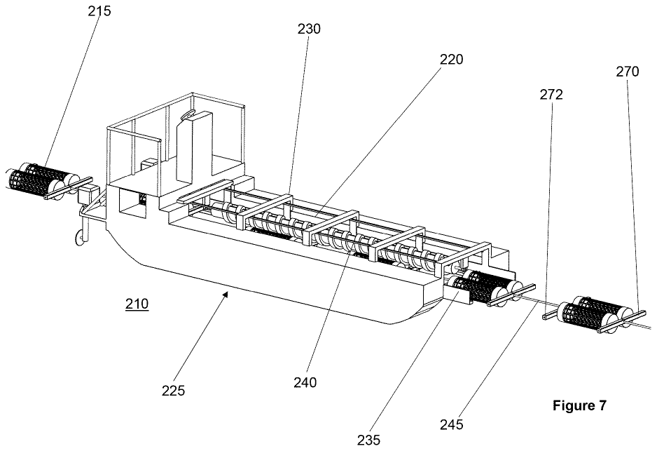

With reference to FIGS. 6, 7 and 8 and according to yet another embodiment of the present disclosure, an aquafarming system 210 is shown. The aquafarming system 210 is further comprised of at least one shellfish container 215 to grow shellfish and a container tumbling device 220 operatively engaged with the at least one shellfish container 215. In the present embodiment, the container tumbling device 220 is shown constructed as part of a pontoon 225; however, in another embodiment, the container tumbling device 220 can be attached to a pontoon 225 or other type of ship instead. By way of example not intended to be limiting, the container tumbling device 220 can have a pair of brackets (not shown) secured to an upper portion 230 to be secured alongside a ship. The container tumbling device 220 further comprises a guiding mechanism 235 to guide the shellfish containers 215 through the container tumbling device 220 as well as an engaging mechanism 240 configured to rotate the shellfish containers 215 as the shellfish containers pass through the container tumbling device 220. As shown in this specific embodiment, the plurality of shellfish containers 215 are disposed in pairs along a singular line 245 as best shown in FIG. 6. In another embodiment, two lines 245 could be used, if disposed on the outside edges of brackets 270, 272. The configuration of the shellfish containers 215 in pairs is preferred because it allows the line 245 to be centered in between adjacent shellfish containers 215 of each pair. In another embodiment, there could be single shellfish containers 215 or more than two. The line 245 terminates in a pair of buoys 250, 252, the buoys 250, 252, anchored to the seabed by cables 255, 257. The shellfish containers 215 remain on the water surface, partially submerged but able to rotate about an axis. Indeed, the shellfish containers 215 are generally cylindrically shaped, having a mesh housing 260 capped by a pair of opposed crowns 265, 267. In this specific embodiment, each pair of shellfish containers 215 is comprised of opposed brackets 270, 272 positioned beyond the crowns 265, 267, respectively. In another embodiment, the brackets 270, 272 may be comprised of a connector such as a screw eye to be disposed along the line 245. In yet another embodiment, the brackets 270, 272 can be clamped in place along the line 245. The shellfish containers 215 also comprise an axle 275 extending longitudinally, generally along the center of each shellfish container 215. The axle 275 extends through the crowns 265, 267 and is secured into each of the opposed brackets 270, 272. The axle 275 therefore enables the shellfish containers 215, including the crowns 265, 267, to rotate about their central axis. The crowns 265, 267 are configured to float and therefore provide flotation to the shellfish containers 215, enough for the shellfish containers 215 to be partially submerged in the water.

The brackets 270, 272 have a central opening (not shown) to receive the singular line 245. In another embodiment, the brackets 270, 272 can simply be secured to the line 245 without a central opening. In this way, the shellfish containers 215 are disposed along and secured to the cable 245. Each shellfish container 215 also comprises an axle 275 extending longitudinally along the center of the shellfish containers 215. The axle 275 enables the shellfish containers 215 to rotate about their central axis.

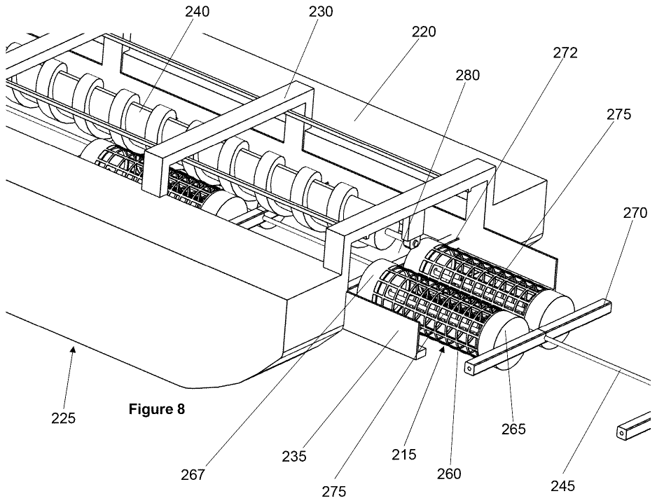

With further reference to FIG. 8 and according to an embodiment of the present disclosure, the upper portion 230 of the container tumbling device 220 has an engaging mechanism 240 configured to rotate the shellfish containers 215 as they pass through and under the container tumbling device 220. In this specific embodiment, the engaging mechanism 240 is an auger with brushes that runs parallel along the length of the container tumbling device 220 and boat 225. The container tumbling device 220 has a guiding mechanism 235 that is adapted to receive the brackets 270, 272 thereby guiding the shellfish containers 215 through and under the container tumbling device 220. In the present embodiment not intended to be limiting, the guiding mechanism 235 is a pair of longitudinal L-shaped brackets that define an opening 280. However, other mechanical structures are possible, provided that they guide the shellfish containers 215 into and under the tumbling device 220. By way of example not intended to be limiting, the guiding mechanism 235 can include a series of opposed wheels or rollers. In yet another embodiment, the guiding mechanism 235 may be omitted from the container tumbling device 220 altogether, and in such an embodiment, the opening 280 of the container tumbling device 220 would simply align with and receive the containers 215 to engage the engagement mechanism 240.

With further reference to FIGS. 6, 7 and 8 and according to an embodiment of the present disclosure, during operation, the container tumbling device 220 passes over and along the line 245 of shellfish containers 215. To do so, the opening 280 of the guiding mechanism 235 is aligned with the first pair of shellfish containers 215 along the length of the shellfish containers 215. As the container tumbling device 220 approaches the first pair of shellfish containers 215, the guiding mechanism 235 receives the first brackets 272, then the pair of shellfish containers 215, then the second bracket 270. As the pairs of shellfish containers 215 are spread along the line 245, subsequent adjacent pairs of shellfish containers 215 follow the first pair of shellfish containers 215 through and under the container tumbling device 220. Once into the opening 280, an upper portion of the mesh housing 260 of the pair of shellfish containers 215 contacts the longitudinal auger and brushes of the engagement mechanism 240. In this embodiment, the auger is disposed along the length of the container tumbling device 220 and rotates in this direction. Similarly, the pairs of shellfish containers 215 are disposed parallel with the line 245 (i.e. the direction of travel), such that the shellfish containers 215 are configured to rotate about their central axle 275, which is similarly parallel to the line 245 and auger. As such, this cooperation between the brushes of the engagement mechanism 240 and the mesh housing 260 forces the shellfish containers 215 to rotate about axle 275, the axle 275 being parallel to the direction of the container tumbling device 220. The shellfish contained within the shellfish containers 215 tumble by virtue of this rotation. As the auger and brushes extend along the length of the container tumbling device 220, continued movement of the boat 225 along the row of shellfish containers 215 engenders continued rotation of the pairs of shellfish containers 215 while moving underneath the container tumbling device 220.

A worker skilled in the art would appreciate that although the shellfish containers 15, 115, 215 are generally cylindrically shaped, they could be another shape, for example shaped as a hexagon, octagon, decagon, provided that the rotation of the containers 15, 115, 215 is not impeded.

Many modifications of the embodiments described herein as well as other embodiments may be evident to a person skilled in the art having the benefit of the teachings presented in the foregoing description and associated drawings. It is understood that these modifications and additional embodiments are captured within the scope of the contemplated disclosure which is not to be limited to the specific embodiment disclosed.

1. An aquafarming system comprising:
at least one shellfish container to grow shellfish; and
a container tumbling device operatively engaged with the at least one shellfish container,
wherein the container tumbling device includes an engaging mechanism configured to actuate the at least one shellfish container as the at least one shellfish container passes through the container tumbling device and below the engaging mechanism.

2. The aquafarming system of claim 1, wherein the engaging mechanism rotates and cleans the at least one shellfish container as the at least one shellfish container passes below the engaging mechanism.

3. The aquafarming system of claim 1, wherein the engaging mechanism has a lower surface that actuates an upper portion of the at least one shellfish container.

4. The aquafarming system of claim 1, wherein the at least one shellfish container includes crowns capping each end of the at least one shellfish container.

5. The aquafarming system of claim 1, wherein the at least one shellfish container further comprises retention members positioned at opposed ends of the at least one shellfish container to guide the at least one shellfish container.

6. The aquafarming system of claim 5, wherein the retention members are brackets with central openings to receive a pair of lines.

7. The aquafarming system of claim 1, wherein the at least one shellfish container includes at least one central axle extending through each end of the at least one shellfish container to facilitate rotation of the at least one shellfish container.

8. The aquafarming system of claim 1, wherein the engagement mechanism is moveable to adjust a height of the engagement mechanism relative to the at least one shellfish container.

9. The aquafarming system of claim 1, wherein the container tumbling device further comprises a guiding mechanism to guide the at least one shellfish container through the container tumbling device.

10. A container tumbling device for use in aquafarming, comprising:
a housing having brackets; and
an engaging mechanism secured to the brackets of the housing, wherein the engaging mechanism is configured to actuate at least one shellfish container as the at least one shellfish container passes through and below the container tumbling device,
wherein the bracket is operable to secure the container tumbling device to a vessel.

11. The container tumbling device of claim 10, wherein the engaging mechanism rotates and cleans the at least one shellfish container as the at least one shellfish container passes below the engaging mechanism.

12. The container tumbling device of claim 10, wherein the engaging mechanism has a lower surface that actuates an upper portion of the at least one shellfish container.

13. The container tumbling device of claim 10, wherein the at least one shellfish container comprises crowns capping each end of the at least one shellfish container.

14. The container tumbling device of claim 10, wherein the at least one shellfish container further comprises retention members positioned at opposed ends of the at least one shellfish container to guide the at least one shellfish container.

15. The container tumbling device of claim 14, wherein the retention members are brackets with central openings to receive a pair of lines.

16. The container tumbling device of claim 10, wherein the at least one shellfish container includes at least one central axle extending through each end of the at least one shellfish container to facilitate rotation of the at least one shellfish container.

17. The container tumbling device of claim 10, wherein the engagement mechanism is moveable to adjust a height of the engagement mechanism relative to the at least one shellfish container.

18. The container tumbling device of claim 10, further comprising a guiding mechanism to guide the at least one shellfish container through the container tumbling device.

19. A method for tumbling a plurality of shellfish containers, the steps comprising:
arranging the plurality of shellfish containers along a pair of lines; and
running the plurality of shellfish containers through and below a container tumbling device including:
a housing having brackets; and
an engaging mechanism secured to the brackets of the housing,
wherein the plurality of shellfish containers cooperates with the pair of lines to be guided relative to the container tumbling device, and
wherein the engaging mechanism rotates the plurality of shellfish containers as the plurality of shellfish containers travels under and through the container tumbling device.

20. The method of claim 19, further comprising attaching the housing of the container tumbling device to a vessel, wherein the vessel travels relative to the pair of lines to tumble the plurality of shellfish containers.
